(19) United States
(12) Patent Application Publication
(10) Pub. No.: US 2014/0028962 A1
(43) Pub. Date: Jan. 30, 2014

(54) VERTICAL ALIGNMENT LIQUID CRYSTAL DISPLAY WITH DIRECTIONAL ELECTRODES

(71) Applicant: INNOLUX CORPORATION, Miao-Li County (TW)

(72) Inventors: SHENG-CHANG CHEN, MIAO-LI COUNTY (TW); WEN-MING HUNG, MIAO-LI COUNTY (TW); YU-CHENG LIN, MIAO-LI COUNTY (TW); CHUEH-JU CHEN, MIAO-LI COUNTY (TW)

(73) Assignee: INNOLUX CORPORATION, Miao-Li County (TW)

(21) Appl. No.: 14/038,299

(22) Filed: Sep. 26, 2013

Related U.S. Application Data
(63) Continuation of application No. 12/941,072, filed on Nov. 7, 2010.

(51) Int. Cl. G02F 1/1343

(52) U.S. Cl. CPC G02F 1/134309
USPC 349/139

(57) ABSTRACT

An exemplary vertical alignment liquid crystal display (LCD) includes a first substrate, a second substrate opposite to the first substrate, a liquid crystal layer disposed between the first and second substrates, first electrodes formed at an inner side of the second substrate adjacent to the liquid crystal layer, and second electrodes formed at the inner side of the second substrate adjacent to the liquid crystal layer. The liquid crystal layer comprises a plurality of liquid crystal molecules having the positive dielectrics constants and being vertically aligned. The first electrodes and the at least one second electrode are configured for generating electric fields to drive the liquid crystal molecules to orient in a plurality of different directions all parallel to the first substrate and the second substrate.

### BACKGROUND

1. Field of the Invention

The present disclosure relates to vertical alignment liquid crystal displays (LCDs).

2. Description of Related Art

Since liquid crystal displays are thin and light, consume relatively little electrical power, and generally do not exhibit flickering, they have helped spawn product markets such as laptop personal computers. The first type of LCD developed was the TN (twisted nematic) mode LCD. Even though TN mode LCDs have been put into use in many applications, they have an inherent drawback that cannot be eliminated; namely, a very narrow viewing angle. By adding compensation films in the TN mode LCDs, this problem can be ameliorated to some extent. However, the cost of such a TN mode LCD is increased. Therefore, a multi-domain vertical alignment (MVA) mode LCD was developed. In an MVA mode LCD, each pixel is divided into multiple domains. Liquid crystal molecules of the pixel are vertically aligned when no voltage is applied, and are inclined in different directions according the domains where they are located when a voltage is applied. In other words, in each pixel, the effective direction of the electric field in one domain is different from the effective direction of the electric field in a neighboring domain. A typical MVA mode LCD uses protrusions and/or slits to form the domains.

However, when fabricating the MVA LCD, an additional process is need for forming the protrusions and/or slits. Thus the method for fabricating the MVA LCD is correspondingly complicated and costly. Furthermore, light leakage may occur due to the presence of the protrusions and/or slits structure, and when this happens the MVA LCD has a lower contrast ratio.

What is needed, therefore, is a vertical alignment LCD which can overcome the described limitations.

### BRIEF SUMMARY OF THE INVENTION

A vertical alignment LCD includes a first substrate, a second substrate opposite to the first substrate, a liquid crystal layer disposed between the first and second substrates, a plurality of first electrodes formed at an inner side of the second substrate adjacent to the liquid crystal layer, and at least one second electrode formed at the inner side of the second substrate. The liquid crystal layer comprises a plurality of liquid crystal molecules having the positive dielectrics constants and being vertically aligned. The first electrodes and the at least one second electrode are configured for generating electric fields to drive the liquid crystal molecules to orient in a plurality of different directions all parallel to the first substrate and the second substrate.

Other novel features and advantages will become more apparent from the following detailed description when taken in conjunction with the accompanying drawings.

### BRIEF DESCRIPTION OF THE SEVERAL VIEWS OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure. All the views are schematic.

FIG. 1 is a plan view of part of a vertical alignment LCD according to a first embodiment of the present disclosure.

FIG. 2 is an enlarged, cross-sectional view corresponding to line II-II of FIG. 1.

FIG. 3 is an enlarged view of one pixel region of the vertical alignment LCD of FIG. 1, but only showing a plurality of first electrodes thereof

FIG. 4 is similar to FIG. 3, but only shows a plurality of second electrodes of the vertical alignment LCD.

FIG. 5 is similar to FIG. 2, but showing alignments of liquid crystal molecules when the vertical alignment LCD is in an on state.

FIG. 6 is a plan view of part of a vertical alignment LCD according to a second embodiment of the present disclosure.

FIG. 7 is a cross-sectional view corresponding to line VII-VII of FIG. 6.

FIG. 8 is a plan view of part of a vertical alignment LCD according to a third embodiment of the present disclosure.

FIG. 9 is an enlarged view of a portion of FIG. 8.

FIG. 10 is a cross-sectional view of part of a vertical alignment LCD according to a fourth embodiment of the present disclosure.

FIG. 11 is a cross-sectional view of part of a vertical alignment LCD according to a fifth embodiment of the present disclosure.

FIG. 12 is a cross-sectional view of part of a vertical alignment LCD according to a sixth embodiment of the present disclosure.

FIG. 13 is a plan view of part of a vertical alignment LCD according to a seventh embodiment of the present disclosure.

### DETAILED DESCRIPTION OF THE INVENTION

The aforementioned illustrations and following detailed descriptions are exemplary for the purpose of further explaining the scope of the instant disclosure. Other objectives and advantages related to the instant disclosure will be illustrated in the subsequent descriptions and appended drawings.

Reference will now be made to the drawings to describe, preferred and exemplary embodiments in detail.

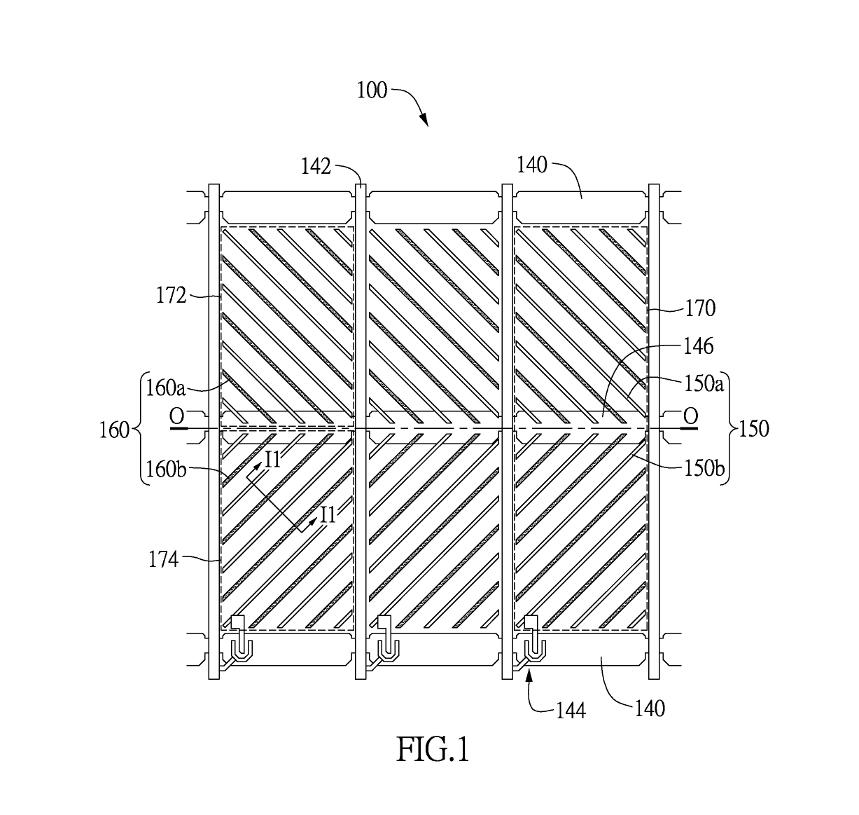

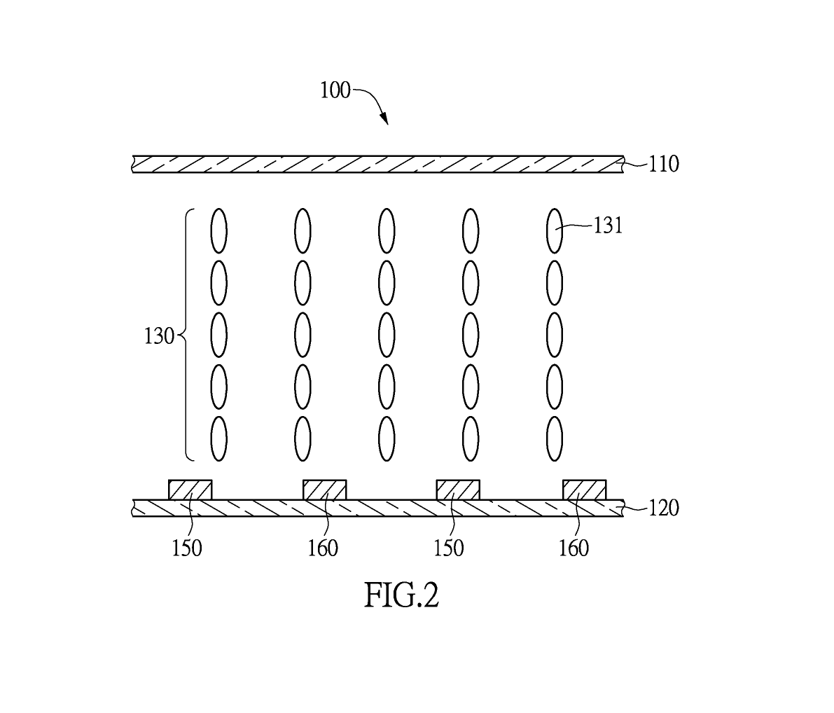

Referring to FIG. 1 and FIG. 2, a schematic view of a vertical alignment LCD according to a first embodiment of the present disclosure is shown. The vertical alignment LCD 100 includes a first substrate 110, a second substrate 120 opposite to the first substrate 110, and a liquid crystal layer 130 sandwiched therebetween. The liquid crystal layer 130 includes a plurality of liquid crystal molecules 131 having positive dielectrics constants and anisotropic properties.

The vertical alignment LCD 100 further includes a plurality of scanning lines 140 parallel to each other, a plurality of data lines 142 parallel to each other and extending orthogonal to the scanning lines 140, a plurality of thin film transistors (TFTs) 144 at intersections of the data lines 142 and the scanning lines 140, a plurality of first electrodes 150, a plurality of the second electrodes 160 and a plurality of common lines 146 parallel to the scanning lines 140. The scanning lines 140 and the common lines 146 are arranged alternately. The scanning lines 140, the data lines 142, the TFTs 144, the first electrodes 150, the second electrodes 160, and the common lines 146 are disposed on an inner side of the second substrate 120 adjacent to the liquid crystal layer 130.

The scanning lines 140 and data lines 142 cross each other, thereby defining an array of pixel regions 170. Each pixel region 170 includes a TFT 144, a plurality of the first electrodes 150 and a plurality of the second electrodes 160. The TFT 144 includes a gate electrode connected to a corresponding scanning line 140, a source electrode connected to a corresponding data line 142, and a drain electrode connected to one of the first electrodes 150 adjacent thereto.

Each pixel region 170 may he divided into two sub-pixel regions, e,g, a first sub-pixel region 172, and a second sub-pixel region 174, by an axis O-O which is parallel to the scanning line 140. Preferably, the axis O-O is in the middle of the pixel region 170.

Each first electrode 150 is rectilinear and has two extending directions. Each first electrode 150 includes a first sub-electrode 150a in the first sub-pixel region 172 and a second sub-electrode 150b in the second sub-pixel region 174. The first sub-electrode 150a extends from a middle of the first electrode 150 toward a periphery of the first sub-pixel region 172 along a first extending direction which is inclined to the axis O-O. The second sub-electrode 150b extends from the middle of the first electrode 150 toward a periphery of the second sub-pixel region 174 along a second extending direction which is also inclined to the axis O-O. Preferably, the first and second sub-electrodes 150a, 150b form a right angle, the first sub-electrode 150a and the scanning line 140 define an angle of about 45 degrees therebetween, and the second sub-electrode 150b and the scanning line 140 define an angle of about 45 degrees therebetween. In FIG. 1, the first sub-electrode 150a extends through the first sub-pixel region 172 from bottom-right to top-left, and the second sub-electrode 150b extends through the second sub-pixel region 174 from top-right to bottom-left.

The first sub-electrodes 150a in each first sub-pixel region 172 are parallel to each other with a uniform distance between any two adjacent first sub-electrodes 150a. The first sub-electrodes 150a may have a uniform width. The second sub-electrodes 150b in each second sub-pixel region 174 are parallel to each other with a uniform distance between any two adjacent second sub-electrodes 150b. The second sub-electrodes 150b may have a uniform width. The first and second sub-electrodes 150a, 150b are both straight.

Each second electrode 160 includes a third sub-electrode 160a in the first sub-pixel region 172 and a fourth sub-electrode 160b in the second sub-pixel region 174. The third sub-electrode 160a extends from a middle of the second electrode 160 toward the periphery of the first sub-pixel region 172 along the first extending direction which is inclined to the axis O-O. The fourth sub-electrode 160b extends from the middle of the second electrode 160 toward the periphery of the second sub-pixel region 174 along the second extending direction which is also inclined to the axis O-O.

The third sub-electrodes 160a in each first sub-pixel region 172 are parallel to each other with a uniform distance between any two adjacent third sub-electrodes 160a. The third sub-electrodes 160a may have a uniform width. The third sub-electrodes 160a and the first sub-electrodes 150a are parallel to each other, and arranged alternately. That is, each third sub-electrode 160a has two neighboring first sub-electrodes 150a. Preferably, each third sub-electrode 160a is located halfway between the two neighboring first sub-electrodes 150a, with the third sub-electrode 160a being spaced a same distance apart from the two neighboring first sub-electrodes 150a.

The fourth sub-electrodes 160b in each second sub-pixel region 174 are parallel to each other with a uniform distance between any two adjacent fourth sub-electrodes 160b. The fourth sub-electrodes 160b may have a uniform width. The fourth sub-electrodes 160b and the second sub-electrodes 150b are parallel to each other, and arranged alternately. That is, each fourth sub-electrode 160b has two neighboring second sub-electrodes 150b. Preferably, each fourth sub-electrode 160b is located halfway between the two neighboring second sub-electrodes 150b, with the fourth sub-electrode 160b being spaced a same distance apart from the two neighboring second sub-electrodes 150b. The third and fourth sub-electrodes 160a, 160b are both straight.

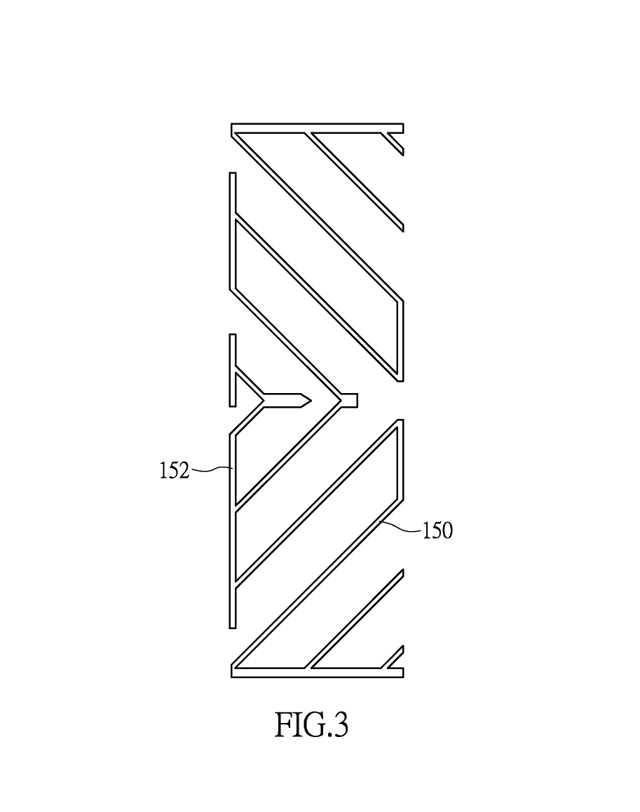

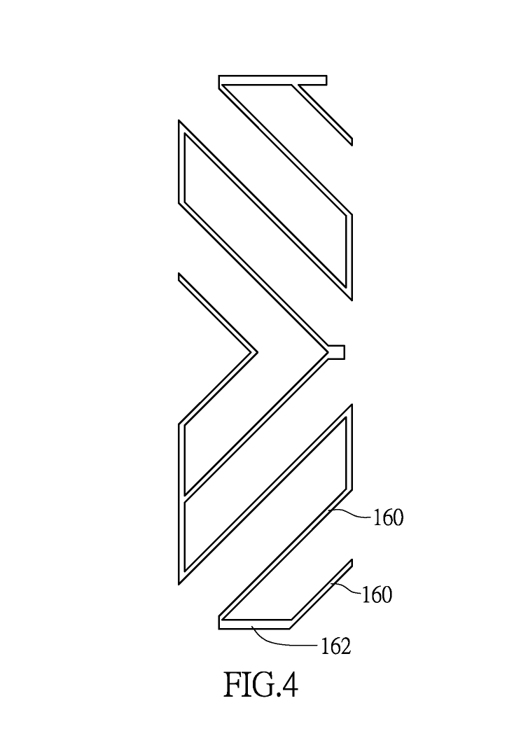

When the vertical alignment LCD 100 is in an on state, in each pixel region, a same pixel voltage is applied to the first electrodes 150, and a same common voltage is applied to the second electrodes 160 via the common line 146. The first electrodes 150 are electrically connected to each other by a connection structure so as to have a same voltage, and the second electrodes 160 are electrically connected to each other by a connection structure so as to have a same voltage. The connection structures may have any of various configurations. For example, referring to FIG. 3 and FIG. 4, the first electrodes 150 are connected to each other by a plurality of first connection portions 152, and the second electrodes 160 are connected to each other by a plurality of second connection portions 162.

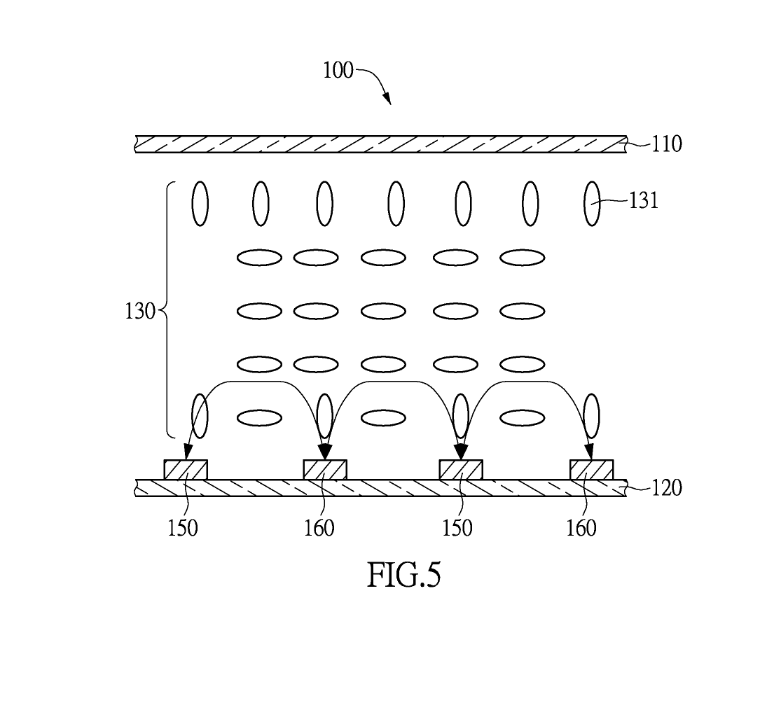

Referring also to FIG. 2 and FIG. 5, when the vertical alignment LCD 100 is in an off state, that is, corresponding pixel and common voltages are not applied to the first and second electrodes 150, 160, respectively, long axes of the :liquid crystal molecules 131 are vertically aligned perpendicular to the first and second substrates 110, 120. As a result, the vertical alignment LCD 100 is in a dark state, in which no image is displayed.

When the vertical alignment LCD 100 is in the on state, corresponding pixel and common voltages are applied to the first and second electrodes 150, 160, respectively. Accordingly, an electric field E is generated between each first electrode 150 and the two corresponding adjacent second electrodes 160. Because the liquid crystal molecules 131 have positive dielectrics constants and anisotropic properties, they are oriented in directions parallel to the electric field E. As a result, the vertical alignment LCD 100 is in a white state, in which an image can be displayed. The electric field E includes a horizontal component parallel to the first and second substrates 110, 120, and a vertical component perpendicular to the first and second substrates 110, 120. In the region adjacent to the first and second electrodes 150, 160, the perpendicular component is stronger, and the liquid crystal molecules 131 are aligned perpendicular to the first and second substrates 110, 120. In the region between the first and second electrodes 150, 160, the horizontal component is stronger, and the liquid crystal molecules 131 are aligned parallel to the first and second substrates 110, 120.

The electric field E varies gradually, and so in different regions of the electric field E, the horizontal component and the perpendicular component affect the orientations of the liquid crystal molecules 131 differently. That is, inhomogeneous rotation angles of the liquid crystal molecules 131 result from the inhomogeneous distribution of the electric field E. Because the first and second electrodes 150, 160 are parallel to each other, and provided on the one same second substrate 120, the horizontal component is generally stronger than the perpendicular component in most of the regions of the electric field E. Thereby, most of the liquid crystal molecules 131 are aligned parallel to the first and second substrates 110, 120 in regions having the stronger horizontal component, while some of the liquid crystal molecules 131 are aligned perpendicular to the first and second substrates 110, 120 in regions having the stronger perpendicular component.

Furthermore, the electric field F adjacent to the second substrate 120 is stronger than that adjacent to the first substrate 110 far away from the second substrate 120. Thus, the liquid crystal molecules 131 adjacent to the first substrate 110 maintain their original orientations, perpendicular to the first and second substrates 110, 120.

As detailed above, each of the first and second electrodes 150, 160 have two extending directions. That is, the first and third sub-electrodes 150a, 160a extend along the first extending direction, and the second and fourth sub-electrodes 150b, 160b extend along the second extending direction. Therefore, the direction of the electric field E generated between the first and third sub-electrodes 150a, 160a is different from the direction of the electric field E generated between the second and fourth sub-electrodes 150b, 160b. Because the first and second electrodes 150, 160 are provided on the one same second substrate 120, the horizontal component is generally stronger than the perpendicular component at most regions of the electric field E. Thereby, most of the liquid crystal molecules 131 are aligned parallel to the first and second substrates 110, 120. Additionally, in the first sub-pixel region 172, the horizontal component of the electric field E is perpendicular to the first extending direction, and in the second sub-pixel region 174, the horizontal component of the electric field E is perpendicular to the second extending direction. Therefore the directions of the electric field E in the first and second sub-pixel regions 172, 174 are perpendicular to each other, and the liquid crystal molecules 131 in the pixel region 170 have additional different alignment directions. Thus overall, the vertical alignment LCD 100 provides a better display performance at various viewing angles.

In summary, because the first and second electrodes 150, 160 are disposed on the one same second substrate 120, when the electric field E is supplied, most of the liquid crystal molecules 131 are aligned parallel to the first and second substrates 110, 120. In addition, in each pixel region 170, each of the first and second electrodes 150, 160 has two extending directions, thereby providing alignment directions of the liquid crystal molecules 131. Thus the vertical alignment LCD 100 provides a better display performance at various viewing angles. Furthermore, these advantages are achieved without the need for an additional process of forming protrusions and/or slits. Thus, fabricating the vertical alignment LCD 100 is correspondingly simple and inexpensive.

Moreover, when the vertical alignment LCD 100 is in an of state, all the liquid crystal molecules 131 are aligned perpendicular to the first and second substrates 110, 120. Because the light transmission ratio of the liquid crystal molecules 131 along their long axes is the lowest, there is little or no light leakage in the off state. That is, the vertical alignment LCD 100 is sufficiently black in the off state. When the vertical alignment LCD 100 is in the on state, most of the liquid crystal molecules 131 are aligned parallel to the first and second substrates 110, 120. Because the light transmission ratio of the liquid crystal molecules 131 along their short axes is the highest, the vertical alignment LCD 100 is sufficiently white in the on state, and has high contrast.

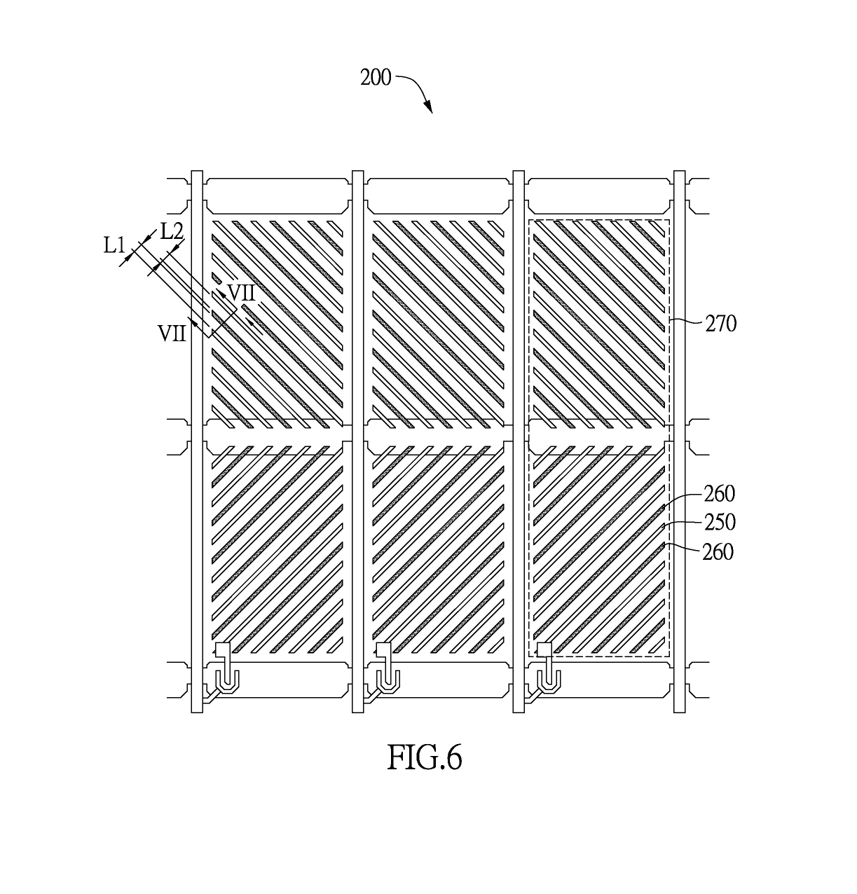

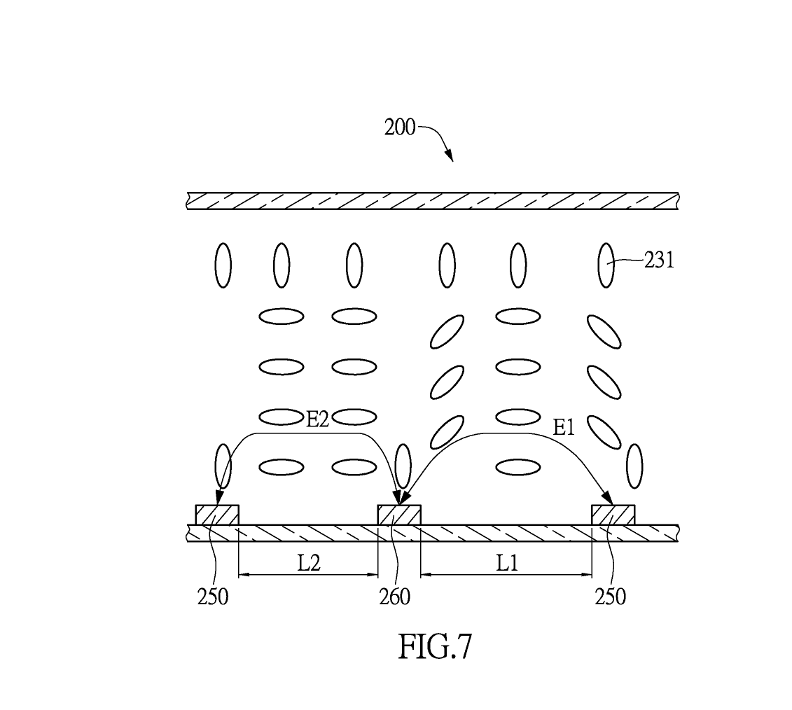

Referring to FIG. 6 and FIG. 7, a vertical alignment LCD 200 according to a second embodiment of the present disclosure is similar to the vertical alignment LCD 100 of the first embodiment. However, each of second electrodes 260 of the vertical alignment LCD 200 has two neighboring first electrodes 250, and at least one second electrode 260 is not located halfway between two neighboring first electrodes 250. That is, for each such second electrode 260, a distance L1 between the second electrode 260 and one neighboring first electrode 250 is different from a distance L2 between the second electrode 260 and the other neighboring first electrode 250. In this embodiment, the distance L1 is longer than the distance L2. Preferably, each of the distance L1 and the distance L2 is in a range from 4 .mu.m to 10 .mu.m.

Because the distance L1 and distance L2 are different, the strength of the electric field E generated by the first and second electrodes 250, 260 spaced the distance L1 is different from that of the electric field E generated by the first and second electrodes 250, 260 spaced the distance L2. Therefore the liquid crystal molecules 231 have additional different alignment directions, and the vertical alignment LCD 200 provides a better display performance at various viewing angles.

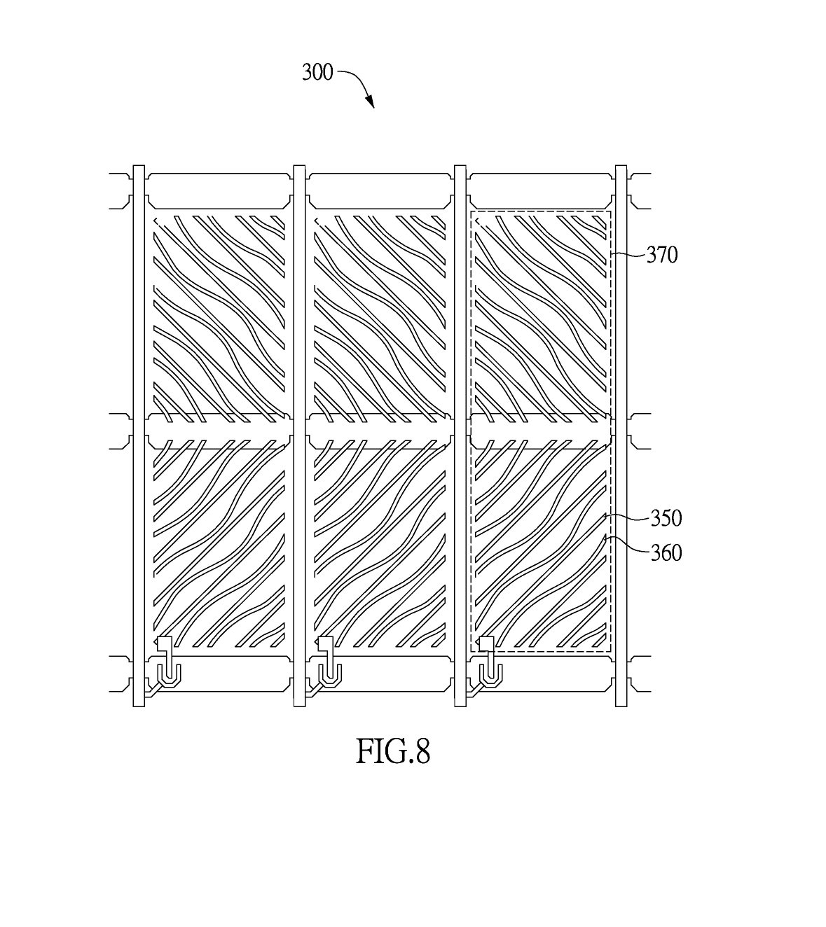

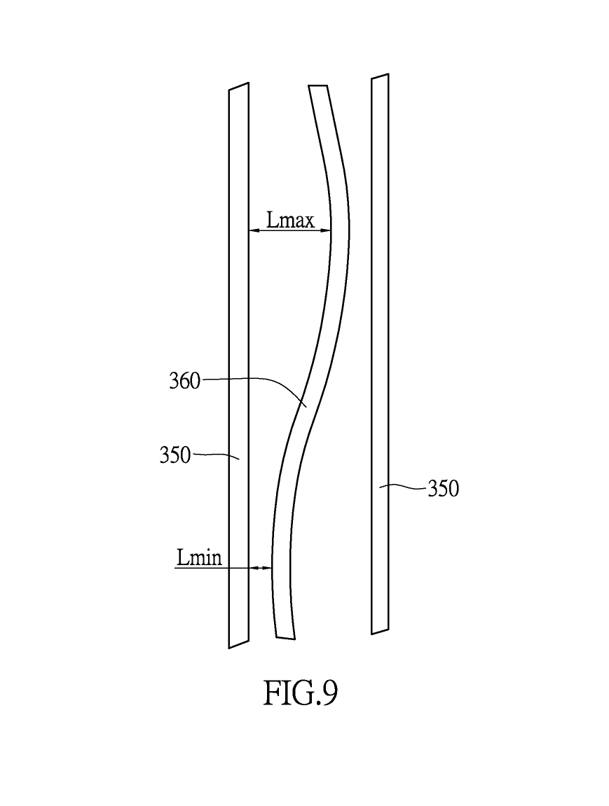

Referring to FIG. 8 and FIG. 9 a vertical alignment LCD 300 according to a third embodiment of the present disclosure is similar to the vertical alignment LCD 100 of the first embodiment. However, each of second electrodes 360 has a curved shape, such that the liquid crystal molecules 331 are directed to incline in various directions in smooth continuums. Thus the vertical alignment LCD 300 can provide a better display performance at various viewing angles, in the illustrated embodiment, the second electrodes 360 are wavy (or serpentine). Each curved second electrode 360 defines a plurality of tangent lines, and the tangent lines are inclined in various directions in a smooth continuum along the length of the second electrode 360. Each tangent line maintains an angle relative to the first extending direction of the first electrode 350, and preferentially, the angles of the tangent lines are in a range from 0 degrees to 15 degrees. Because each second electrode 360 has a curved shape, a distance L from the first electrode 350 to the second electrode 360 varies gradually. Typically, the distance L varies in a range from 3.5 .mu.m to 13.5 .mu.m. Preferably, a minimum distance Lmin is about 4.5 .mu.m, a maximum distance Lmax is about 8 .mu.m. A width of each first electrode 350 is about 3.5 .mu.m, and a width of each second electrode 360 is about 3.5 .mu.m. A thickness of the liquid crystal layer is about 3.5 .mu.m. Also preferably, a ratio of the dielectric constant of the liquid crystal molecules 131 in their long axes to the dielectric constant of the liquid crystal molecules 131 in their short axes is about 10. Accordingly, the liquid crystal molecules 131 of the vertical alignment LCD 300 have a short response time when they twist.

The shape of the second electrodes 360 is not limited to the above-described embodiments. For example, each of the second electrodes 360 can be wavy, comprising multiple gently curved “S” shapes. Each of the second electrodes 360 can be gently “S” shaped. Each of the second electrodes 360 can be arcuate.

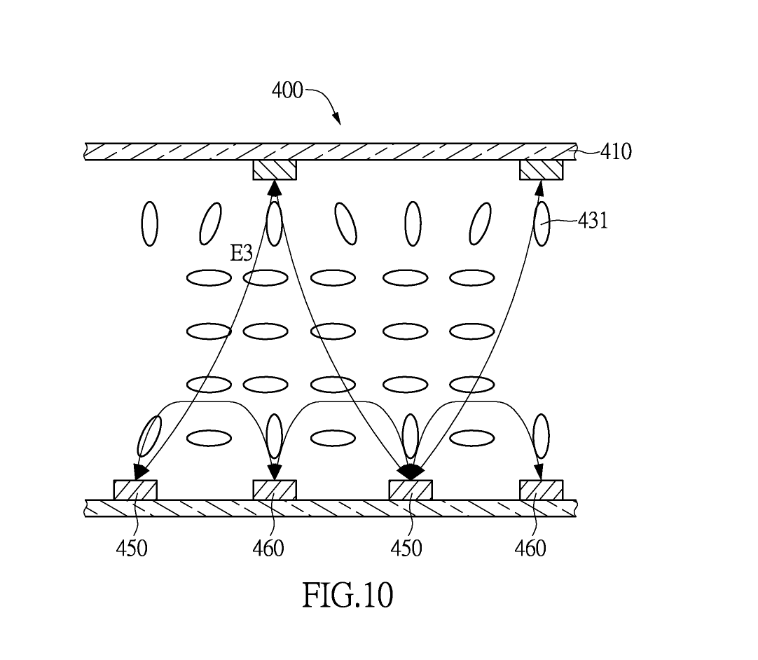

Referring to FIG. 10, a vertical alignment LCD 400 according to a fourth embodiment of the present disclosure is similar to the vertical alignment LCD 100 of the first embodiment. However, the vertical alignment LCD 400 further includes a plurality of third electrodes 462. The third electrodes 462 are disposed on an inner side of a first substrate 410 adjacent to a liquid crystal layer 430. Each third electrode 462 corresponds to a second electrode 460. Preferably, an extending direction and a shape of each third electrode 462 is the same as each second electrode 460. The liquid crystal molecules 431 adjacent to the first substrate 410 align parallel to the direction of the electric field E3 generated by the third electrode 462 and the first electrode 460.

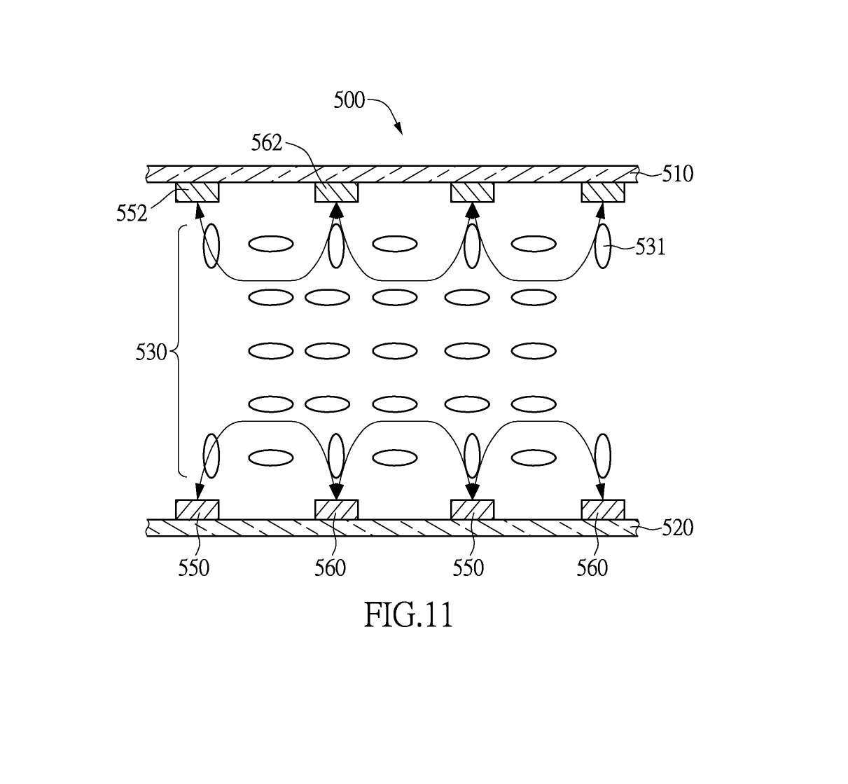

Referring to FIG. 11, a vertical alignment LCD 500 according to a fifth embodiment of the present disclosure is similar to the vertical alignment LCD 400 of the fourth embodiment. However, the vertical alignment LCD 500 further includes a plurality of fourth electrodes 552. The fourth electrodes 552 are disposed on an inner side of a first substrate 510 adjacent to a liquid crystal layer 530. Each fourth electrode 552 corresponds to one respective first electrode 550. Preferably, an extending direction and a shape of each fourth electrode 552 is the same as each first electrode 550. A same pixel voltage as the first electrode 550 is supplied to the fourth electrode 552, an electric field E is formed between the third and fourth electrodes 562, 552, and liquid crystal molecules 531 adjacent to the first substrate 510 are aligned parallel to the electric field E, that is parallel to the first and second substrates 510, 520.

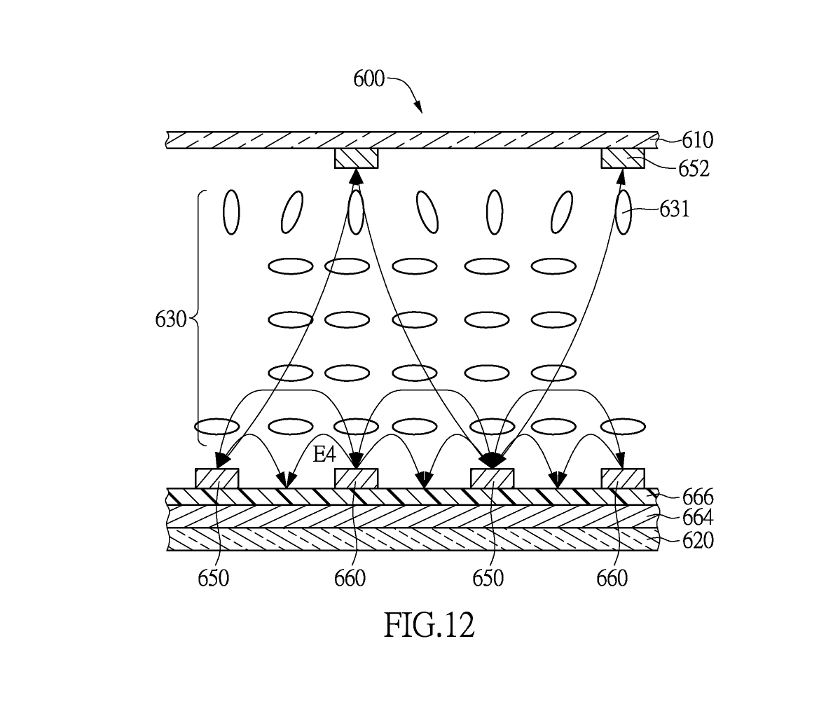

Referring to FIG. 12, a vertical alignment LCD 600 according to a sixth embodiment of the present disclosure is similar to the vertical alignment LCD 400 of the fourth embodiment. However, the vertical alignment LCD 600 further includes an electrode layer 664 and an insulating layer 666. The electrode layer 664 is disposed on the second substrate 620, and the insulating layer 666 is disposed between the electrode layer 664 and a plurality of first electrodes 650. Preferably, the first electrodes 650 and a plurality of second electrodes 660 are disposed between a liquid crystal layer 630 and the insulating layer 666. A plurality of third electrodes 652 are disposed on an inner side of a first substrate 610 adjacent to the liquid crystal layer 630. A same common voltage as the second electrodes 660 is supplied to the electrode layer 664, and a plurality of peripheral electric fields E4 are formed by the first electrodes 650 and the electrode layer 664. Therefore more liquid crystal molecules 631 are aligned parallel to the first and second substrates 610, 620.

The vertical alignment LCD 600 is not limited to the above-described embodiments. For example, the insulating layer 666 may still be disposed between the electrode layer 664 and the first electrodes 650, but with there being no second electrodes 660 and no third electrodes 652 provided on the second and first substrates 620, 610, respectively. In such case, the common voltage is applied to the electrode layer 664, the pixel voltage is applied to the first electrodes 650 and liquid crystal molecules 631 are directed to incline only by the peripheral electric fields E4 generated by the first electrodes 650 and the electrode layer 664.

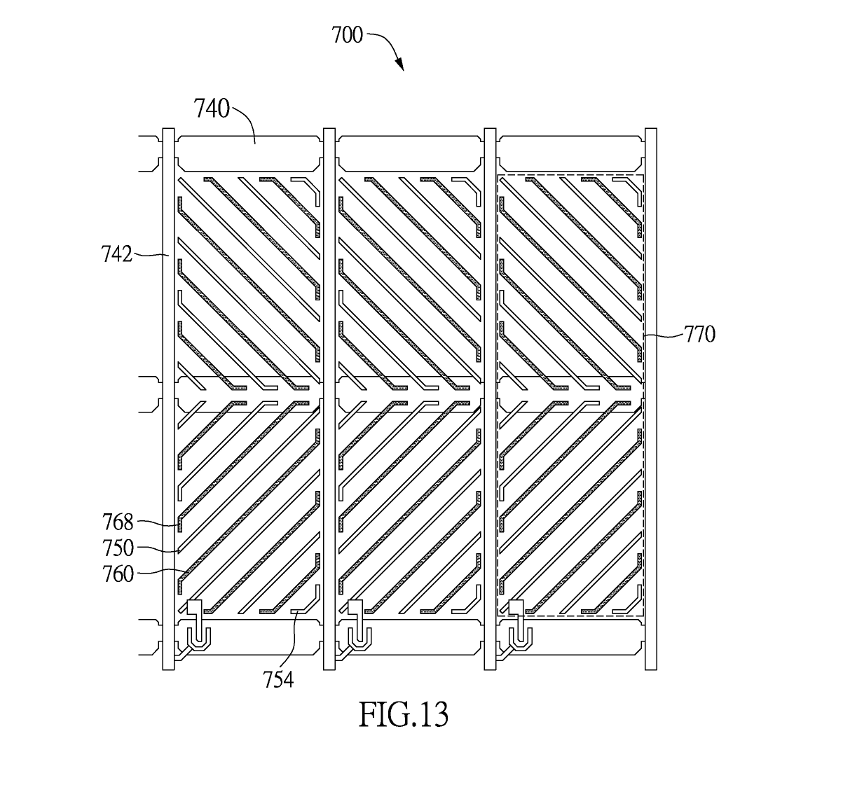

Referring to FIG. 13, a vertical alignment LCD 700 according to a seventh embodiment of the present disclosure is similar to the vertical alignment LCD 100 of the first embodiment. Each of pixel regions 770 further includes a plurality of first extending portions 754 connected to opposite ends of certain of first electrodes 750, and a plurality of second extending portions 768 connected to opposite ends of certain of second electrodes 760. Those first extending portions 754 which are adjacent to a scanning line 740 are parallel to the scanning line 740. Those first extending portions 754 which are adjacent to a data line 742 are parallel to the data line 742. Those second extending portions 768 adjacent to a scanning line 740 are parallel to the scanning line 740. Those second extending portions 768 adjacent to a data line 742 are parallel to the data line 742. The first and second extending portions 754, 768 can drive the liquid crystal molecules in the peripheries of the first and second sub-pixel regions to twist fast, and thereby prevent dark lines from being generated in the peripheries of the first and second sub-pixel regions.

The vertical alignment LCD of this disclosure is not limited to the above-described embodiments. For example, in the third embodiment of the present disclosure, the first electrodes 350 can he curved in the same way as the second electrodes 360.

It will be further apparent to those skilled in the art that various modifications can be made to the present embodiments without departing from the scope or spirit of the disclosure. In view of the foregoing, it is intended that the present disclosure cover modifications and variations of the embodiments provided that such modifications or variations fall within the scope of the following claims or their equivalents. Any one of the embodiments or any one of the claims of the disclosure does not necessarily have to achieve all of the advantages or features disclosed herein. Moreover, the abstract and the headings are merely used to aid in searches of patent files and are not intended to limit the scope of the claims.

What is claimed is:

1. A liquid crystal display comprising:
a first substrate;
a second substrate opposite to the first substrate;
a liquid crystal layer disposed between the first substrate and the second substrate; and
a first electrode disposed on the second substrate, comprising:
at least two first portions, extending along a first direction, and a first distance therebetween; and
at least two second portions, individually connected to the first portions, extending along a second direction, and a second distance therebetween;
wherein the first direction is different from the second direction, and the first distance is different from the second distance.

2. The liquid crystal display according to claim 1 further comprising a plurality of scanning lines and a plurality of data lines disposed on the second substrate, thereby defining a plurality of pixel regions, and a second electrode disposed in the pixel region.

3. The liquid crystal display according to claim 2, wherein a pixel voltage is applied to the first electrode and a common voltage is applied to the second electrode.

4. The liquid crystal display according to claim 2, wherein at least two of the first portions are neighboring to the second electrode, and distances from the second electrode to the two neighboring first portions are different.

5. The liquid crystal display according to claim 2, wherein an insulating layer is disposed between the first electrode and the second electrode.

6. The liquid crystal display according to claim 2 further comprising a third electrode disposed on the first substrate, wherein a same voltage is applied to the second electrode and the third electrode.

7. The liquid crystal display according to claim 2 further comprising a fourth electrode disposed on the first substrate, wherein a same voltage is applied to the first electrode and the fourth electrode.

8. The liquid crystal display according to claim 1, wherein the first electrode further comprises a plurality of third portions, extends along a third direction, and the third direction is different from the first direction and the second direction.

9. The liquid crystal display according to claim 8, wherein the first extending direction is inclined to a corresponding one of the scanning lines.

10. The liquid crystal display according to claim 1, wherein the first portions of the first electrode are electrically connected to each other by at least one first connection portion.
